(19) United States
(12) Patent Application Publication
(10) Pub. No.: US 2012/0050069 A1
(43) Pub. Date: Mar. 1, 2012

(54) SYSTEM FOR REMOTELY MANAGING PARKING AREAS

(76) Inventors: Denis Mercier, Quebec (CA); Marc A. Fortier, Quebec (CA); Jacques Dorval, Quebec (CA)

(21) Appl. No.: 13/032,325

(22) Filed: Feb. 22, 2011

Related U.S. Application Data
(63) Continuation of application No. 12/830,942, filed on Jul. 6, 2010, now abandoned.
Application No. 12/830,942 is a continuation of application No. 12/523,701, now abandoned.

(30) Foreign Application Priority Data
Jan. 17, 2007 (CA) 2573634

(51) Int. Cl. G08G 1/14

(52) U.S. Cl. 340/932.2

(57) ABSTRACT

A system for remotely managing one or more parking areas having one or more equipment, the system comprising a central server, a control module associated with each of the equipment, each control module being in communication with the central server. Wherein each control module is operative in controlling its associated equipment and wherein the central server is operative in providing configuration parameters to each control module.

### FIELD OF THE INVENTION

The present invention generally relates to a system for remotely managing parking areas. More specifically, the present invention is concerned with managing various components of parking areas, including a management of revenues and control of access.

### BACKGROUND OF THE INVENTION

There exist many systems for managing one or another feature, or a combination thereof, that is required in order to manage and operate properly a parking area. Some are aimed at customers having a subscription, authors are aimed at hourly customers, yet others are concerned with security. A drawback is that a parking area employee has to master features from all such systems and work with different interfaces, since all the existing systems can hardly be integrated one with another.

### SUMMARY OF THE INVENTION

in accordance to the present invention, there is provided a system for remotely managing one or more parking areas having one or more equipment, the system comprising:

a central server;

a control module associated with each of the equipment, each control module being in communication with the central server;

wherein each control module is operative in controlling its associated equipment, and

wherein the central server is operative in providing configuration parameters to each control module.

The foregoing and other objects, advantages and features of the present invention will become more apparent upon reading of the following non-restrictive description of illustrative embodiments thereof, given by way of examples only, with reference to the accompanying drawings.

### BRIEF DESCRIPTION OF THE DRAWINGS

In the appended drawings:

FIG. 1 is a schematic view of a system for remotely managing parking areas according to an illustrative embodiment of the present invention;

FIG. 2 is a schematic view of a parking area local area network; and

FIGS. 3a and 3b show examples of screens from a graphical interface for use with the system of FIG. 1.

### DETAILED DESCRIPTION OF THE INVENTION

Generally stated, the non-limitative illustrative embodiment of the present invention provides a system and method for remotely managing a parking areas, including the management of a back-office (revenues) inherent to efficient management and proper control of access to the parking areas.

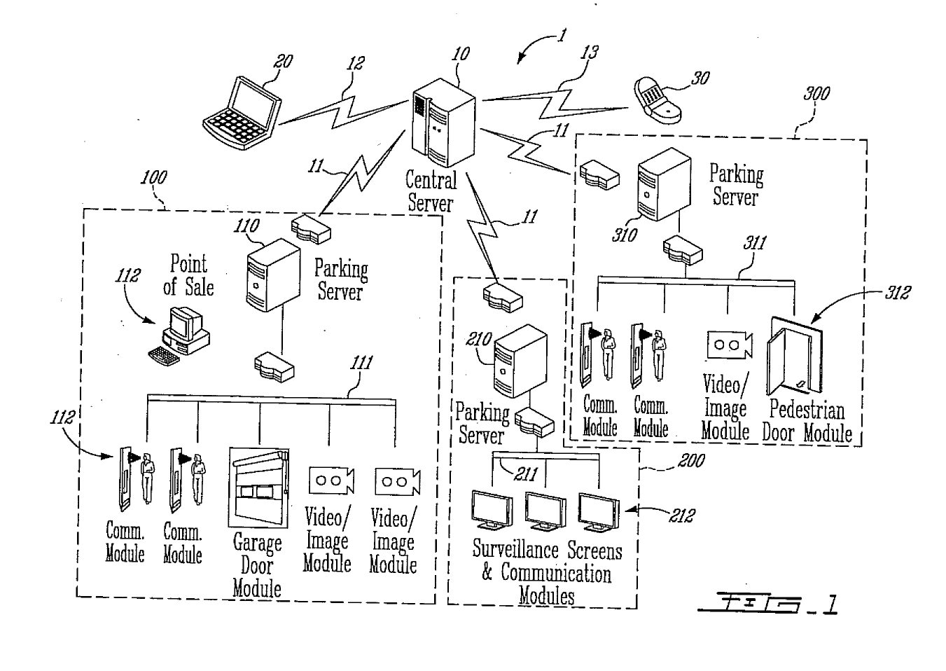

Referring to FIG. 1, the system for remotely managing parking areas (SRMPA) 1 of the non-restrictive illustrative embodiment comprises a central server 10 connected to one or more parking area servers 110, 210 and 310 located at various respective parking areas 100, 200 and 300 through communication links 11 such as, for example, an asymmetric digital subscriber line (ADSL). The parking area servers 110, 210 and 310 serve as gateways to the various equipments 112, 212 and 312 at each of the parking areas 100, 200 and 300 through, for example, a local communication network (wired or wireless) 111, 211 and 311.

A graphical Interface on the central server 10 allows access to the various equipments 112, 212 and 312 through a single interface and a single system, independently of the type of customer, e.g. hourly, monthly, etc., and the type of parking area 100, 200 and 300. Through this single graphical interface, a user can remotely manage services associated with each equipment 112, 212 and 312 in order to control, for example, access to the parking areas 100, 200 and 300, security thereof, revenues therefrom, and provide customer service.

By clusterizing the control of all of the equipments 112, 212 and 312 under a common system, e.g. the SRMPA 1, it is possible to properly meet the specific requirements and characteristics of a wide variety of parking areas. For example, such requirements and characteristics may pertain to designated reserved areas, variable schedules, common passes for accessing a parking area as well as a hotel room, etc. The SRMPA 1 may also be used to manage rebates afforded to certain types of customers, for example customers attending activities at a Congress Center.

The use of the SRMPA 1 also facilitates the maintenance of the various equipments 112, 212 and 312 offered in the various parking areas 100, 200 and 300. Having a common interface for all of the equipments 112, 212 and 312 eliminates the need to manage teams of after-sale support personnel from multiple manufacturers when problems arise. The SRMPA 1 allows for the remote diagnostic of problems and the performing of preventive maintenance on all of the equipments 112, 212 and 312 by a single user, which is trained to support a single system instead of a plurality of different systems.

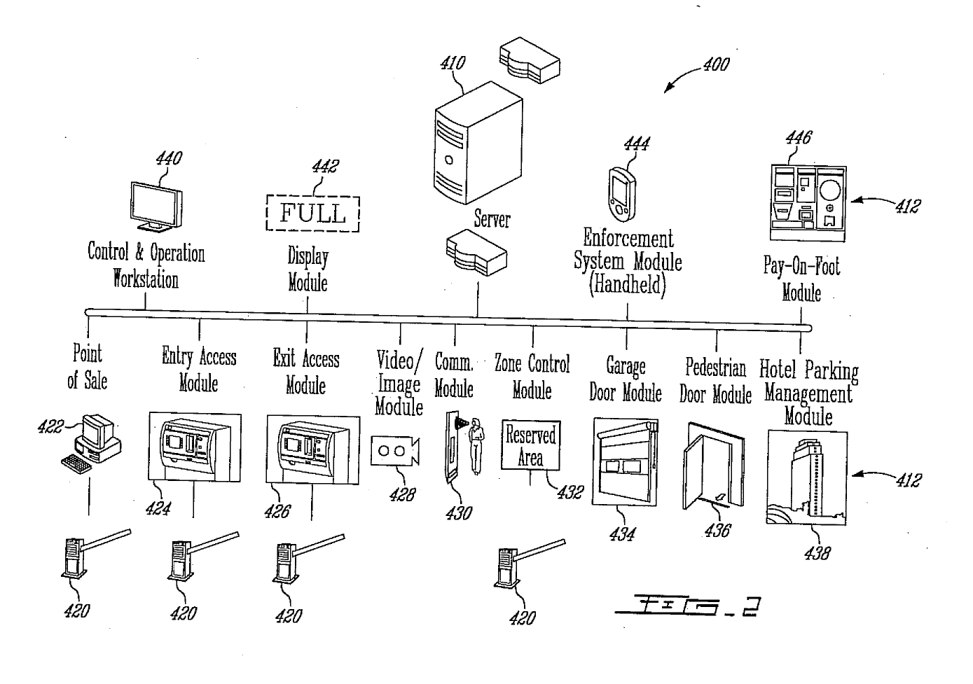

Referring to FIG. 2, there is shown an example of a parking area 400 having a parking area server 410 connected through local area network 411 to a series of equipments 412, each having a control module and associated functionalities (which will be further detailed below). The parking area server 410 allows the communication of the central server 10 with the Individual control modules of the equipments 412. Management of the various equipments and their functionalities 412 is enabled by the transfer of configuration parameters from the central server 10 to the control modules of each of the equipments 412.

The configuration parameters can be configured both in a centralized and a decentralized fashion via the graphical interface of the central server 1 (see FIG. 1), e.g. they may be the same for all equipments 412 of the same type or they may be individually set. Configuration parameters and information are exchanged between the central server 1, the parking area server 410 and the control modules of the equipments 412 using, for example, an XML format.

A given parameterization enables to define:
the types of services provided by the equipment, e.g. sale of periodical permits, issuance of hourly tickets, credit card access, debit card access, acceptance of daily permits, acceptance of special events permits, acceptance of fixed rates, monthly customers access, etc.
the underlvinq business Iodic, e.g. validation rules required in order to ensure optimal Internal control, for example stopping a customer from accessing a parking area more then once at a time, block monthly permits holders which have not paid their monthly fees, overbill customers leaving a parking area outside of specified hours, allow access to parking areas to monthly customers according to the schedules they subscribed to, limit the number of customers which may subscribe to services offered at a parking area, limit payment options to specific schedules (for example, limit debit card access to evenings after 5:00 pm Monday to Friday and on weekends), etc.;
the accepted and/or refused document types, e.g. debit cards, credit cards, microchip cards, transponders, bar codes, etc.; and
the operation scenarios, e.g. handling of specific events, for example when the occupancy attains 85% of its total capacity, not accepting any more hourly customers and display “Parking Full—Monthly Permit Holders Only” or only accept monthly permit holders during the day and opening the parking area to hourly customers at night, etc.

Thus, parameterization gives the SRMPA 1 the capability of defining operation scenarios of the various services provided that take into account the business logic of the parking areas 100, 200 and 300 (see FIG. 1) according to an application schedule, e.g. according to the day and time, or specific events. The operation scenarios that are so defined can be used to characterize one or more of the parking areas 100, 200 and 300. It is to be understood that each parking area 100, 200 and 300 may have its own specific set of configuration parameters (decentralize configuration) and that within each parking area 100, 200 and 300, each equipment 112, 212 and 312 may also have its own set of configuration parameters. It is also to be understood that sets of configuration parameters may also be set globally across similar equipments 112, 212 and 312 or parking areas 100, 200 and 300 (centralized configuration).

These operation scenarios enable, in real-time, the displaying of messages, the playing of audio messages and the offering of services according to the business logic of the parking areas 100, 200 and 300 wherein the application schedule is based on a day and a time and/or a real-time breakdown of the number of customers having a monthly permit and hourly customers present in the in a parking area 100, 200 and 300.

As previously mentioned, with reference to FIG. 2, a control module is associated with each equipment 412 in order to receive the configuration parameters and enable its functionalities accordingly. Typically, the control modules communicate by means of a TCP/IP protocol in a Windows environment over the local area network 411, although other protocols and/or environments may be used.

The control modules include the following.

### Point of Sale Module

The point of sale module 422 is used in order to manage and control access to the parking area by customers. The point of sale module 422 is installed and interfaced with an access restriction equipment such as, for example, a gate 420, at an entry of the parking area 400 and uses configuration parameters defining the services provided by this equipment, the underlying business logic, document types that are accepted and/or rejected and operation scenarios. Far example, the paint of sale can be manned by an attendant during normal business hours, which may render a variety of services such as, for example, providing access to hourly customers, selling monthly passes, etc., and set to operate independently after normal business hours.

### Entry Access Module

The entry access module 424 is used in order to manage and control access to the parking area 400 by customers holding a monthly permit as well as hourly customers. The entry access module 424 is installed and interfaced with an access restriction equipment such as, for example, a gate 420, at an entry of the parking area 400 and uses configuration parameters defining the services provided by this equipment, the underlying business logic, document types that are accepted and/or rejected and operation scenarios. For example, only accept monthly permit holders during the day and opening the parking area 400 to hourly customers at night.

### Fixed-Rate Sale Module

A fixed rate sale module (not shown) may also be used in combination with the entry access module 424, or on its own at the entry of the parking area 400, in order to allow hourly customers to pay access fees for a predetermined period of time on the basis of a fixed amount so as to encourage a massive and fast exit of the customers.

### Exit Access Module

The exit access module 426 is used in order to manage and control exit from a parking area 400 by customers holding a monthly permit as well as hourly customers. The exit access module 426 is installed and interfaced with an access restriction equipment such as, for example, a gate 420, at an exit of the parking area 400 and uses configuration parameters defining the services provided by this equipment, the underlying business logic, document types that are accepted and/or rejected and operation scenarios. For example, exit access module 426 can enable the billing of monthly customers who exit the parking area 400 outside of their authorized time slot.

### Video/Image Module

The video/image module 428 is used in order to provide visual surveillance of all, or a portion of, the parking area 400. The video/image module 428 is installed and interfaced with a digital imaging system such as, for example, a fixed or remote control digital camera, and enables the transfer of digital images, in real-time or differed time, between parking areas or to the SRMPA 1 (see FIG. 1) in order to remotely provide support and ensure the security of customers. In the case of a remote control digital camera, the video/image module 428 may also allow the remote control of the digital camera from another parking area or from the SRMPA 1.

### Communication Module

The communication module 430 is used in order to manage and control an audio communication system in order to provide support to customers of the parking area 400. The communication module 430 is installed and interfaced with au audio communication system such as, for example, an intercom, and enables audio communications between parking areas or with the SRMPA 1 (see FIG. 1) in order to allow an attendant in one parking area, or the SRMPA 1, to communicate with a remote customer at another parking area.

### Zone Control Module

The zone control module 432 is used in order to manage and control access to certain zones, e.g. reserved zones of the parking area 400. The zone control module 432 is installed and interfaced with an access restriction equipment such as, for example, a gate 420, at the entry of a reserved zone in order to give access thereto only to customers who have paid a fee for parking that reserved zone and uses configuration parameters defining the services provided by this equipment, the underlying business logic, document types that are accepted and/or rejected and operation scenarios. Furthermore, the zone control module 432 may be used to define a logical hierarchy of reserved zones, such as to make possible the management of sub-zones inside a given reserved zone.

### Garage Door Module

The garage door module 434 is used in order to manage and control access to the parking area 400 by an authorized customer. The garage door module 434 is installed and interfaced with each garage door giving access to the parking area 400 and uses configuration parameters defining the services provided by this equipment, the underlying business logic, document types that are accepted and/or rejected and operation scenarios. For example, access to the parking area 400 may be controlled according to authorized time slots corresponding to customers having a monthly permit or other types of customers. In another example, a customer may have access to the parking area 400 only at night. In a further example, the customer may use a payment card only after a given hour.

### Pedestrian Door Module

The pedestrian door module 436 is used in order to manage and control pedestrian doors giving access to the parking area 400 by an authorized customers. The pedestrian door module 436 is installed and interfaced with each pedestrian door giving access to the parking area 400 and uses configuration parameters defining the services provided by this equipment, the underlying business logic, document types that are accepted and/or rejected and operation scenarios. For example, the pedestrian door module 436 may be configured so that only customers having a monthly permit or hourly customers having a vehicle inside the parking area 400 can have access to the parking area 400 through the pedestrian door.

### Cyclist Access Module

A cyclist access module (not shown) may also be used in combination with the pedestrian door module 436, and is similar to the latter, except that the it manages and controls access to the parking area 400 through pedestrian doors for cyclists having a permit to access the parking area 400.

### Hotel Parking Management Module

The hotel parking management module 438 is used in order to manage and control access to the parking area 400 by hotel customers. The hotel parking management module 438 is installed, for example, in hotel lobbies and is interfaced with the other modules herein described in order to manage and control hotel customers access to parking areas during their stay at the hotel.

### Control and Operation Workstation Module

The control and operation workstation module 440 is used in order to manage and control the various control modules of the parking area 400. For example, it may be used to interface with the video/image module 428 in order to provide surveillance of the parking area 400 or with the communication module 430 in order to answer customer queries. The control and operation workstation module 440 may also be used to access the parking area server 410 or the SRMPA 1 to, for example, modify the configuration parameters of one or more control module.

### Display Module

The display module 442 is used in order to manage and control the display of informative messages inside and outside the parking area 400 as well as in public access such as, for example, streets, boulevards, etc. The pedestrian door module 436 is installed and Interfaced with a visual display such as, far example, a LED or LCD display, in order to inform customers and potential customers as to the availability of parking spaces, provided services, directions to the available parking spaces, schedules, rates, payment options, etc.

### Enforcement System Module

The enforcement system module 444 is used in order to manage and control a parking area 400 deprived of barriers. The enforcement system module 444 is installed and interfaced with a handheld device, such as a portable computer or other computing device, to be used by patrollers in order to enforce parking regulations. Enforcement can be carried out by means of stickers, permits or license plates, in which case the handheld device may include an optical scanner for reading the stickers, permits or license plates. If a vehicle is found to infringing regulations, the handheld device may immediately issue a statement of offence, in which case the handheld device may include a printer, and, optionally, manage the towing of the infringing vehicle.

### Pay-on-Foot Module

The pay-on-foot module 446 is used in order to manage and control the payments, by customers, of their hourly or monthly fees. The pay-on-foot module 448 is installed and interfaced with an automated pay station placed in the perking area 400, in an adjacent building or public space, on a street, etc. and uses configuration parameters defining the services provided by this equipment, the underlying business logic, document types that are accepted and/or rejected and operation scenarios. Furthermore, a customer can buy a access packages by means of a microchip card allowing the customer to park in predetermined parking areas.

The entry/exit access modules 424 and 428 may comprise a powerful processing unit allowing the use of a LCD screen in order to direct customers through the various services provided in the parking area 400 as well as display the available payment modes. These LCD screens may be color screens enabling the display of text messages, graphics, images, animated pictograms, videos, etc. It is to be understood that other control modules may also be provided with such processing unit and LCD screen.

Referring back to FIG. 1, customers may also interact remotely with the SRMPA 1 to, for example, make payments, renew or cancel a permit, update personal information, etc. These may be accomplished using control modules present on the SRMPA 1, such as, for example, the internet payment module, the Web site module and the cellular phone payment module, which will be described further below.

### Internet Payment Module

The internet payment module allows registered customers to pay their parking access fees via their financial institution. The access fees payments are then transferred daily from the financial Institution to the SRMPA 1.

### Web Site Module

The Web site module allows registered customers to have, using a personal computer 20 and a communication link 12 such as the Internet, access to their customer file on the SRMPA 1. Through the Web site module, customers can make requests relative to their parking contract, for example renewal or cancellation requests, and update their personal file. Furthermore, hourly customers may also buy short-term parking access packages or submit a request for a monthly permit.

### Cellular Phone Payment Module

The cellular phone payment module allows registered customers, through a cellular phone 30 and a communication link 13, to pay their access fees by means of a cellular phone. Although communication is established with the SRMPA 1, the access fee may be paid for any one of the parking areas 100, 200, 300.

It is to be understood that, in order to pay a fee, an hourly customer can use rebate coupons with any of the control modules dealing with the payment of fees. Should the rebate coupon not be sufficient to cover fee, the residual amount may be paid by credit card, debit card, and/or cellular phone.

It is also to be understood that the functionalities of each of the above described control modules may vary according to their assigned configuration parameters. It is further to be understood that the functionalities of each above described control modules may be modified at any time by providing the control module with a new set of configuration parameters.

According to the parameterization applied to the various equipment 412 control modules, information from other equipment 412 control modules may be required for a given control module to properly operate. For example, when the parameterization is set such that when the occupancy of the parking area 400 attains 85% of its total capacity, no more hourly customers are accepted and the “Parking Full—Monthly Permit Holders Only” is displayed, this requires keeping track of the number of customers entering the parking area 400, which information is provided by the entry access module 924, and the number of customers exiting, which information is provided by the exit access module 426. Finally, when the 85% occupancy is attained, this Information must be conveyed to the display module 442 for the proper message to be displayed. This coordination between the various control modules involved, e.g. 424, 426 and 442, is provided by the parking area server 410.

It is to be understood that the functionalities of some modules may be combined. For example, the entry access module 424, exit access module 425 and the automated pay station module 446 may be combined such that an hourly customer may use a credit card, or other accepted document defined by its assigned configuration parameters, in order to access the parking area 400 and be billed once he or she leaves. Building upon the same example, the functionalities of the video/image module 426 as well as the communication Module 428 may be further added so as to provide audio and video communication in cases where the assistance of an attendant is required.

### Graphical Interface

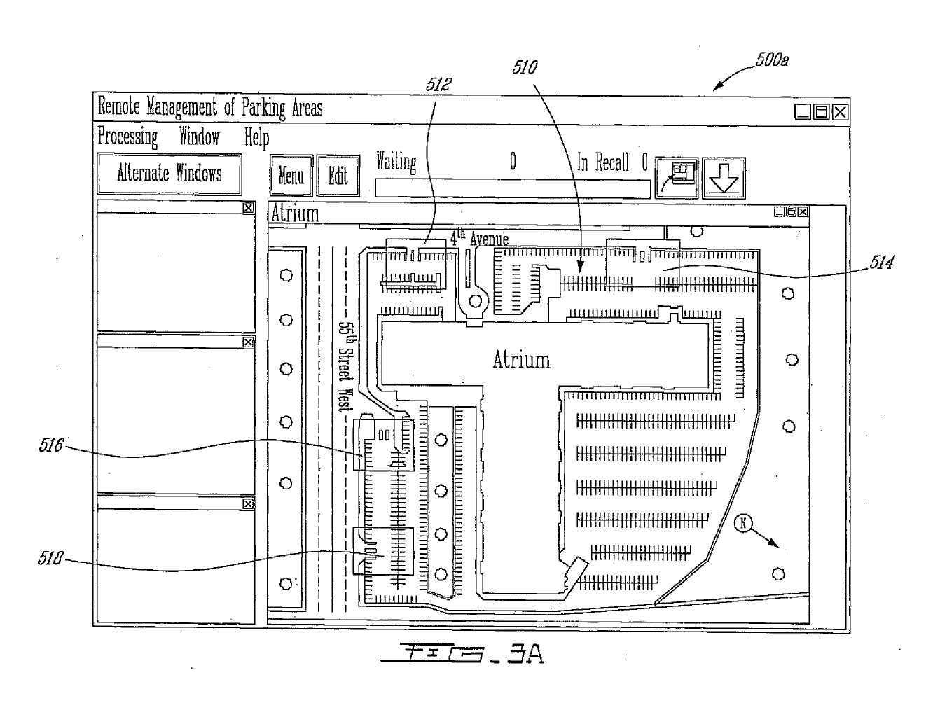

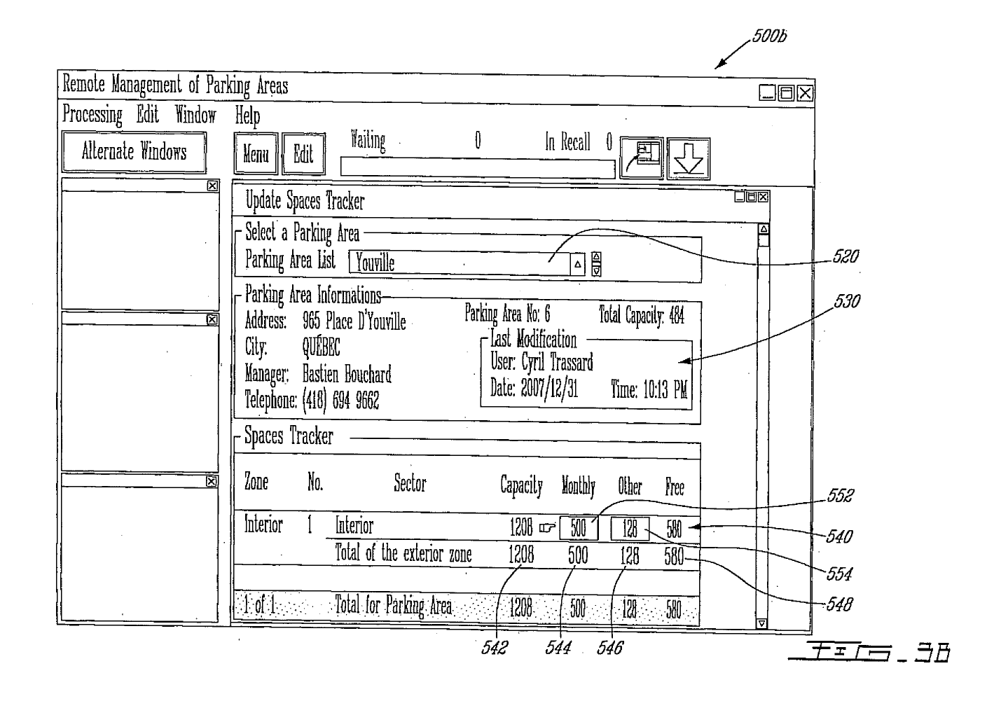

Referring to FIGS. 3a and 3b, there is shown two screens 500a and 500b from an example of a graphical user interface that may be used with the SRMPA 1 (see FIG. 1). Screen 500a shows a graphical representation of a parking area 510 with associated equipments 512, 514, 516 and 518. From this screen 500a a user can select to remotely interact with a selected equipments 512, 514, 516 and 518, either to control it, get a diagnostic, monitor it, send it new configuration parameters, etc. interaction may be in the form of activating the equipment, viewing an area using a camera, communicating with a customer, etc.

As for screen 500b, it shows an example of a basic Interaction screen having a parking area selection field 520, an information display field 530 and a configuration parameters field 540. In this example, the configuration parameters field 540 displays the total capacity 542 of the parking area, the actual number of monthly permit customers 544, hourly customers 546 and total customers 548, present in the in the parking area. From the configuration parameters field 540, a user may set a maximum number of allowable monthly permit customers 552 and/or maximum number of allowable hourly permit customers 554.

Although the present invention has been described hereinabove by way of non-restrictive, illustrative embodiments thereof, these embodiments can be modified at will, within the scope of the appended claims, without departing from the spirit and nature of the subject invention.

1. A system for remotely managing one or more parking areas having one or more equipment, the system comprising:
a central server
a control module associated with each of the equipment, each control module being in communication with the central server,
wherein each control module is operative in controlling its associated equipment, and
wherein the central server is operative in providing configuration parameters to each control module.

2. A system according to claim 1, wherein the configuration parameters include a type of service provided by the equipment associated with the control module.

3. A system according to claim 1, wherein the configuration parameters include a business logic applicable to the equipment associated with the control module.

4. A system according to claim 1, wherein the configuration parameters include a list of documents accepted and rejected by the equipment associated with the control module.

5. A system according to claim 1, wherein the configuration parameters include one or more operation scenario applicable to the equipment associated with the control module.

6. A system according to claim 1, wherein the configuration parameters include at least one element selected from the group consisting of a type of service provided by the equipment associated with the control module, a business logic applicable to the equipment associated with the control module, a list of documents accepted and rejected by the equipment associated with the control module and one or more operation scenario applicable to the equipment associated with the control module.

7. A system according to any one of claims 1 and 6 further comprising a parking area server associated with each of the parking areas, each parking area server being in communication with the central server and the control modules of its associated parking area.

8. A system according to claim 7, wherein the parking area server coordinates an exchange of information between the control modules associated with the equipments of the parking area.

9. A system according any one of claims 1 to 8, wherein the control module associated with the at least one equipment is selected from a group consisting of a point of sale module, an entry access module, an exit access module, a video module, a communication module, a zone control module, a garage door module, a pedestrian door module, a hotel parking management module, a display module, an enforcement system module, a pay-on-foot module, a cyclist access module and a fixed-rate sale module.

10. A system according any one of claims 1 to 9, wherein the central server includes a graphical user interface.

11. A system according to claim 10, wherein the graphical user interface is operative in setting the configuration parameters of the control modules.

12. A system according any one of claims 1 to 11, wherein the central server includes an internet payment module for the electronic payment of fees from a financial institution.

13. A system according any one of claims 1 to 12, wherein the central server includes a web site module for the remote management of customer files.

14. A system according any one of claims 1 to 13, wherein the central server includes a cellular phone payment module for the payment of fees by means of a cellular phone.
